(19) United States
(12) Patent Application Publication
(10) Pub. No.: US 2009/0055728 A1
(43) Pub. Date: Feb. 26, 2009

(54) Decompressing electronic documents

(76) Inventors: Marcel Waldvogel, Stein am Rhein (CH); Jan Van Lunteren, Gattikon (CH); Andreas Kind, Kilchberg (CH)

Correspondence Address: IBM CORPORATION, T.J. WATSON RESEARCH CENTER, P.O. BOX 218, YORKTOWN HEIGHTS, NY, 10598, US

(21) Appl. No.: 12/191,652

(22) Filed: Aug. 14, 2008

Related U.S. Application Data
(63) Continuation of application No. 11/443,525, filed on May 30, 2006.

(30) Foreign Application Priority Data
May 26, 2005 (EP) 09405362

(51) Int. Cl. G06F 17/00

(52) U.S. Cl. 715/237

(57) ABSTRACT

This invention provides methods, apparatus, and systems for decompressing electronic documents. Utility of this invention includes use in validation and parsing of compressed XML documents. An example data processing method comprises receiving a compressed electronic document, decompressing the document and executing an analysis of the document during the decompression. The analysis determines whether the document conforms to defined syntax rules. In one example, a compressed XML document, while it is being decompressed, following receipt, will be parsed and/or validated at the same time.

### FIELD OF THE INVENTION

This invention relates to methods and systems for decompressing electronic documents. The invention can be used in the validation and parsing of compressed XML documents.

### BACKGROUND OF THE INVENTION

In data networks, such as the Internet, it is common practice to transfer information in the form of documents. For example, a web page produced in HTML (Hypertext Markup Language) is a document that is received by a computer and rendered by a browser. HTML is a document description language, which defines the use of tags in documents for such things as formatting and linking to other documents. Likewise, XML is a document description language, which allows the creation of new tags, unlike HTML, where the set of tags is standardized.

When a computer receives a document in HTML or XML, the document is processed by a parser. The document is parsed by an algorithm or program to determine the syntactic structure of the document. This occurs as part of the process of rendering the document for use by the receiving computer. The parsing also determines if the original document is compliant with the syntax rules requirements of the relevant language. For example, within an XML document, it is a requirement that a tag that is used to open an element, for example <name> be followed eventually by a closing tag, in this example, </name>. If the opening tag is never followed by a closing tag then the document is considered invalid. An invalid document will be rejected by the parser. A very large amount of information concerning XML is in the public domain, but for further detail, numerous documents concerning XML are available at http:www.ibm.com/developerworks.

The language XML was created in part to overcome two problems of more traditional forms of data interchange. Firstly, it was common for there to be a lack of self-descriptiveness, which made data hard for receiving devices to understand and for humans to debug. Secondly there existed issues with up- and downward compatibility, for example, such things as the adding of new fields or the changing of existing fields was relatively complicated. However, as a result, XML is very verbose. To reduce the storage and communications overhead, an XML document, prior to transmission, is therefore often compressed. One example of such a compressed XML repository is the format used by OpenOffice (http://www.openoffice.org/). This XML repository consists of a ZIP archive containing individually compressed entries, some of which are XML files, some are other data files.

With the increasing importance and pervasiveness of XML in a variety of applications, including WebServices description languages and remote procedure call languages, for example, SOAP, servers are increasingly under stress from verifying whether an XML document is well-formed and the scanning/parsing of the contents of the document. Due to the frequent use of XML in combination with compression, the standard procedure is to first decompress the data, thereby expanding it, typically by a factor of 3-10, followed by XML processing. As this processing deals with a larger data size and is performed in two separate steps, the XML processing, i.e. validation or parsing is slower.

### SUMMARY OF THE INVENTION

Therefore, according to a first aspect of the present invention, there is provided a data processing method comprising receiving a compressed electronic document, decompressing the document and executing an analysis of the document during the decompression, the analysis determining whether the document conforms to defined syntax rules. According to a second aspect of the present invention, there is provided a data processing system comprising an input device for receiving a compressed electronic document, and a processor unit arranged to decompress the document and to execute an analysis of the document during the decompression, the analysis determining whether the document conforms to defined syntax rules.

According to a second aspect of the present invention, there is provided a data processing system comprising an input device for receiving a compressed electronic document, and a processor unit arranged to decompress the document and to execute an analysis of the document during the decompression, the analysis determining whether the document conforms to defined syntax rules.

According to a third aspect of the present invention, there is provided a computer program product on a computer readable medium for controlling data processing apparatus, the computer program product comprising instructions for a data processing method comprising receiving a compressed electronic document, decompressing the document and executing an analysis of the document during the decompression, the analysis determining whether the document conforms to defined syntax rules.

### DESCRIPTION OF THE DRAWINGS

Embodiments of the present invention will now be described, by way of example only, with reference to the accompanying drawings, in which:

FIG. 1 is a schematic diagram of a data processing system,

FIG. 2 is a flow chart of a combined decompression/parsing, and

FIG. 3 is an example of a string table.

### DESCRIPTION OF THE INVENTION

This invention provides methods, apparatus and systems for decompressing electronic documents. Utility of this invention includes use in validation and parsing of compressed XML documents. In an example embodiment, the present invention provides a data processing method comprising receiving a compressed electronic document, decompressing the document and executing an analysis of the document during the decompression, the analysis determining whether the document conforms to defined syntax rules.

In another example embodiment, the present invention provides a data processing system comprising an input device for receiving a compressed electronic document, and a processor unit arranged to decompress the document and to execute an analysis of the document during the decompression, the analysis determining whether the document conforms to defined syntax rules.

In another example embodiment, the present invention further provides a computer program product on a computer readable medium for controlling data processing apparatus, the computer program product comprising instructions for a data processing method comprising receiving a compressed electronic document, decompressing the document and executing an analysis of the document during the decompression, the analysis determining whether the document conforms to defined syntax rules.

Owing to the invention, it is possible to provide a method for decompressing a document such as a compressed XML document, which will include within the decompression the step of analyzing the document to ensure that it is syntactically correct. This speeds up the processing of the received document and reduces the demand for resources such as processing power and storage within the receiving system. This method and system also has the advantage that it can be utilized solely at the decompression end of the transmission of a compressed document. No change to the compression process is required to gain the benefit of the invention.

Advantageously, the data processing method further comprises terminating the decompression, if the analysis determines that the document does not conform to a defined syntax rule. By terminating the decompression, as soon as a failure is detected in the received document, processing resources are saved. The rest of the decompression does not need to be executed, although a user of such a system could still request that the decompression be continued to completion. Preferably, where the decompression uses a string table, the analysis comprises adding a further column to the string table, the further column comprising syntax (parsing) information. Many compression/decompression schemes use a string table, as the basis for the compression of the starting document. For example, the LZW algorithm, which is a very widely used compression algorithm, uses a string table. For further information on the LZW algorithm resources are available, for example the article “LZW Data Compression” by Mark Nelson can be found at the web address www.dogma.net/markn/articles/lzw/lzw.htm, which is incorporated by reference into this document. A large number of standard technologies use the LZW algorithm, including, for example, the zip compression included within Microsoft operating systems. By basing the combined decompression/analysis on a simple extension to a commonly used compression technique, the system can be easily adopted on a computing device, without the need for any changes to be made at the compression and transmission end of the network.

In an advantageous embodiment, the step of executing an analysis of the document during the decompression comprises parsing or validating the 10 document. Documents in a format such as XML need to be parsed and/or validated before they can be utilized by the receiving system. The combining of the validation or parsing with the decompression of the XML document greatly assists the speed of handling of the document by the receiving system.

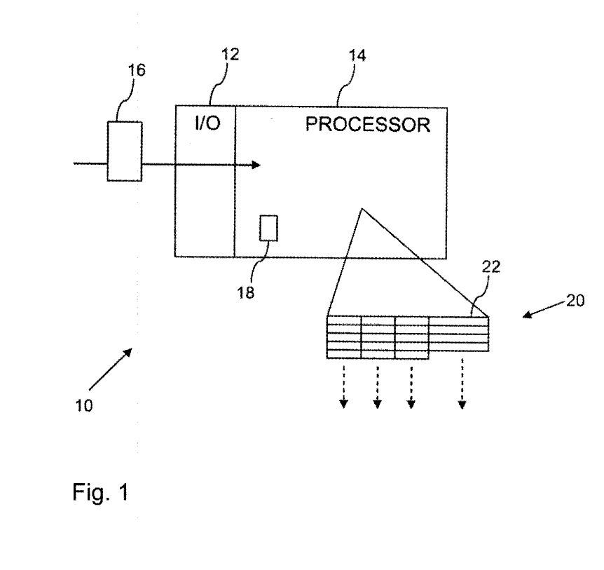

FIG. 1 shows a data processing system 10, which comprises an input device 12 and a processor unit 14. The system 10 forms part of a larger computing system, such as a network server or a desktop PC. The input device 12 is for receiving a compressed electronic document 16, which could be, for example, an XML document 16 that has been requested by the system 10, and has been compressed prior to transmission to the system 10.

The processor 14 is arranged to decompress the document 16 and to execute an analysis of the document 16 during the decompression. The analysis is to determine whether the document 16 conforms to defined syntax rules 18. The analysis can take the form of validation of the document 16, or may comprise the parsing of the document 16.

In effect, the parsing occurs directly on the compressed data, and does not require the document 16 being entirely expanded, which can simplify the creation of a parse tree. The exact method of carrying out the combined decompression/parsing of the document 16 will depend upon the original compression scheme that was used to compress the document 16, before the document 16 was transmitted to the system 10. Two popular compression schemes are discussed below, with respect to the amendment of the decompression in order to simplify the processing of the received XML document 16.

Parsing can be carried out by a state machine. The application of state machines to implement a parser has been a well-investigated research area over the past decades, for example see the book written by A. Aho, R. Sethi, and J. Ullman, “Compilers-Principles, Techniques and Tools,” Addison-Wesley, Reading Mass., 1986. As a result, many modern parsers are based on this concept and implement part of their functionality using state transition tables. The usage of state machines for realizing a parser can, therefore, be regarded as common knowledge for persons skilled in the art. The paper by J. van Lunteren et. al., “XML accelerator engine,” First International Workshop on High Performance XML Processing, in conjunction with the 13th International World Wide Web Conference (WWW2004), New York, N.Y., USA, May 2004, presents the concept of a parser engine that is based on a novel programmable state machine technology that can be used to create high performance parsers directly in hardware. Although the above paper focuses in particular on the parsing of XML documents, the presented concepts are applicable to a much wider spectrum of parser applications.

### LZ78-Based Compression Lempel-Ziv-Welch (LZW)

This compression scheme is very widely used, and is described in, for example, http://datacompression.info/LZW.shtml. The main properties of this compression scheme are as follows: When reading a code word from the compressed file, the value of this code word indexes into a string table 20 that contains information to reconstruct the uncompressed data sequence. To provide a combined decompression and parsing, this scheme is extended by the standard compression/decompression table including a transition description column. In those methodologies that use decompression with a string table 20, the analysis of the document during decompression comprises adding a further column 22 to the string table 20, the further column comprising syntax information.

To explain the amendment to the LZW algorithm on the decompression side, there follows a description of the normal application of LZW, then a description of the amended LZW to validate an XML document simultaneously with the decompression, followed by a methodology for parsing to build a Document nObject Model (DOM) tree.

### 1. Standard LZW Decompression

Symbols are defined as a sequence of b bits, where b is defined by the log2 of the current table size. The table is initialized with all possible atoms, typically, 1-byte units, plus some special symbols, such as ‘end of file’ and possibly “clear table”. That is, typically b starts out as 9 but will extend to 10, once the table reaches its 513th entry. There are also variations with a fixed code length, where all symbols are encoded with the same b. Decompression of a symbol is executed as follows. At the start of the compression, the previous symbol, s′, is undefined.

a. Read next symbol, s
b. Reconstruct the symbol's original value by accessing the table at line s, which gives a component of the original value plus a redirection to a new line of the string table. This redirection continues until it finishes at a basic atom, usually one of lines 1 to 26 representing the letters of the alphabet.
c. If this is not the first symbol read, append a new symbol to the end of the string table which represents the concatenation of s′ and the first atom (character) of the decompressed version of the current symbol, s. This is the complementary function to that which the compressor uses to build the table.
d. Assign s to s′.
2. LZW Decompression & XML Analysis; Check that Document is Well-Formed and Valid

For this analysis, the goal is to verify whether a given document matches the set of rules specified or whether it violates at least one of them. The rules for whether a document is well-formed only include syntactical information, while validation also applies semantic checks. The resulting code for analysis of compressed documents is as follows:

a. Read next symbol, s
b. Access the table at index s, and check for the existence of a state transition description valid for the current verification state.
c. If such a description is present, load the new state from the table.
d. If no matching description is found, run the verifier and store the state transition description in the table at index s. This will typically be done by first applying the transition given for the predecessor, followed by the transition from the last character.
e. If this is not the first symbol read, append a new symbol to the end of the table which represents the concatenation of s′ and the first atom (character) of the decompressed version of the current symbol, s.
f. Assign s to s′

It is not actually necessary to perform the decompression; the analysis can be performed independently of the decompression. The only parts used are applying the state transitions for one symbol, either the current or its predecessor, and on the first use of a symbol applying the state transition resulting from the single final character of the new symbol. The state transition is a tuple (old state, new state), which transforms a given old state into the specified new state. As it is possible that the same symbol can occur in different contexts—for example, in <a href=“href”>, href is, in one place, an attribute and, in a second place, part of the value,—it may be considered advantageous to store multiple (old state, new state) transitions, one for each old state, if the symbol is encountered in multiple old states. This may be done by storing at most a fixed number of tuples or having an associative array—for example, content addressable memory, CAM—instead of the single table entry. A CAM key would be the tuple (s, old state), the value would be the new state. The actual content of the state identifier used depends on the validator.

### 3. LZW Decompression & XML Analysis; Parsing to DOM (or SAX)

The integration with parsing is slightly more involved but still draws on the fact that scanning/parsing results can be reused. The code is related to the validation.

a. Read next symbol, s
b. Access the table at index s, and check for the existence of a parse tree modification (SAX: parse event notification) description valid for the current parser state.
c. If such a description is present, repeat its instructions, for example, implemented as a byte-code.
d. If no matching description is found, run the parser and store the parse tree modification (SAX: parse event notification) description in the table at index s. This will typically be done by first applying the instructions given for the predecessor, followed by the parsing result from the last character. The last parsing step may modify the last instruction(s) parsed, for example, if it finishes a tag/attribute/ . . . which was previously only recognized in part.
e. If this is not the first symbol read, append a new symbol to the end of the table which represents the concatenation of s′ and the first atom (character) of the decompressed version of the current symbol, s.
f. Assign s to s′

Instead of the DOM operations, also SAX events could be stored in case the parse result should be given as SAX as marked above.

Typical DOM operations are listed below. Operations listed as “add” will often be implemented as “copy”, e.g. by including a reference to the previously recognized part. They will be encoded in a bytecode-style language.
i. Continue scanning a token
ii. Create a new tag
iii. Add an attribute to the tag
iv. Add a value to an attribute
v. Add an attribute/value pair
vi. Finish parsing a node
vii. Add a node or subtree
viii. Process a close tag, i.e., move one level up in the parse tree

At the time a symbol is first seen used in the compressed form, its predecessor has already been seen at least twice: A first time, when it was entered into the symbol table; a second time, when the current symbol was entered into the table. Then, the predecessor symbol actually occurred in the stream of compressed symbols.

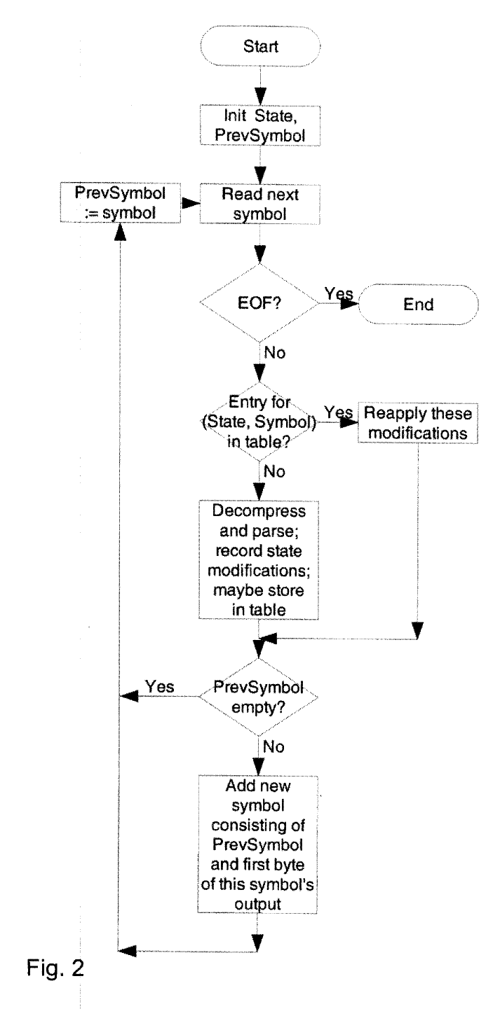

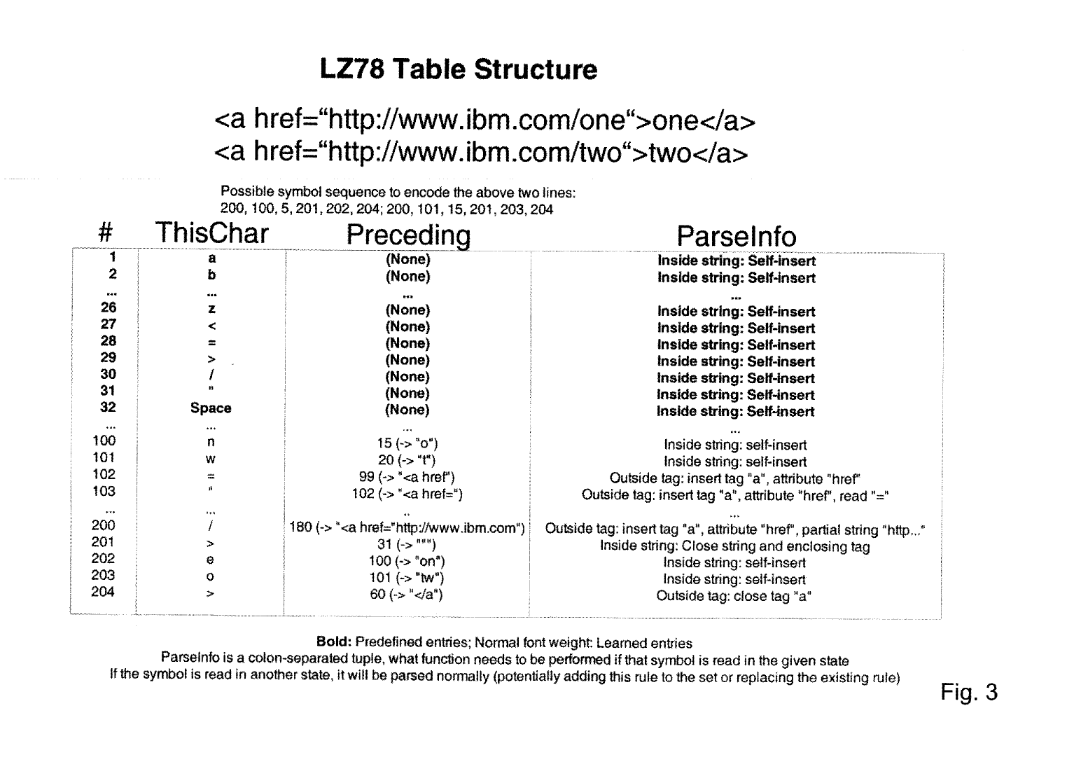

FIG. 2 shows a flowchart for the amended LZW algorithm, which will execute the combined decompression and scanning/parsing. FIG. 3 gives an example of a string table that will be constructed during the decompression of a portion of an XML document.

FIG. 2 illustrates the LZ78 decompression algorithm with integrated scanning/parsing in a flow chart. After initialization of the decompression table ‘Table’ as well as the variables ‘State’ and ‘Previous Symbol’ the next symbol is read and assigned to the variable ‘Symbol’. If ‘Symbol’ indicates that the end of the input (i.e. EOF) has been reached, decompression is finished. Otherwise, it is checked if ‘Table’ contains an entry indexed by ‘Symbol’ and ‘State’. If an entry exists in Table’ the parsing actions associated with this entry are applied, otherwise scanning continues with the chain of decompressed symbols since the last parsing actions have been applied. If the scanning process detects at that stage the end of a token, the corresponding parsing actions are applied and if ‘Previous Symbol’ is not empty stored with an index which is combined by ‘Symbol’ and ‘State’. Before the next symbol is stored in ‘Symbol’, again, the variable ‘Previous Symbol’ is set to ‘Symbol’.

FIG. 3 provides an example of the table during a LZ78 decompression with integrated scanning/parsing. The sample input is:
<ahref=“http://www.ibm.com/one”>one</a>
<ahref=“http://www.ibm.com/two”>two</a>

The table is initialized (see also FIG. 2) with the alphabet and a number of special one character symbols (for example, space, “ ”, ‘<’). The initialized part of the table is indicated in bold font. These initial single character are not linked and, thus, do not refer to any preceding entries in the table. Their related parsing/scanning action is ‘Self-insert’, meaning if they occur in a string, they extend the string by their value. The example assumes that some character chains with associated parsing/scanning information have been added to the decompression table already. For example, index 200 refers to the string “<ahref=http://www.ibm.com/ or index 203 refers to the string “two”. Using the current state of the decompression table the sample input can be encoded as ‘200, 100, 5, 201, 202, 204, 200, 101, 15, 201, 203, 204’.
200-> <a href=“http://www.ibm.com/
100-> on
5 -> e
201-> ”>
202-> one
204-> </a>
200 -> <a href=“http://www.ibm.com/
101 -> tw
15 -> o
201 -> ”>
203-> two
204 -> </a>

The parsing and scanning actions are verbosely written in the ‘ParseInfo’ column. For instance, the parsing/scanning information for index 200 is for the state ‘Outside tag’ to insert a new ‘a’-tag with the given attribute ‘href’ which is set to ‘http://www.ibm.com’.

### LZ77-Based Compression Lempel-Ziv-Huffman (LZH)

The difference between LZH and LZW is that LZH keeps a ring buffer of recently seen cleartext instead of a table of symbols. The tokens read from the compressed file are one of two forms. The first are compression tokens made from (offset, length) tuples pointing into that ring buffer (see for example, http://datacompression.info/LZW.shtml). When receiving such a tuple, the text thereby indicated is copied from the ring buffer into the decompressed stream. The second type of token indicates literal text, which is copied from the token to the decompressed stream. This is used to encode short sequences that would be longer to encode using the (offset, length) tuple or that include symbols that are not currently in the ring buffer, for example, in the beginning, or when a greek letter occurs after a long stretch of ASCII-only text.

In a similar to the LZW algorithm, for each (offset, length) tuple, the decompression algorithm is extended by the inclusion of a description of state transitions or tree operations to be executed. In one embodiment, these are stored in a structure parallel to the text ring buffer and indexed by the offset. Ideally, the element so indexed would contain an associative array where for each possible parser/validator state this may occur; plus a list of lengths and matching transitions/operations. All this information would be constructed on demand. Typical cache management rules apply, as they do in the case when the element can only hold a limited number of such associations. The parser would then pick the description with longest length that is not larger than the length indicated in the (offset, length) tuple. If only a partial result was contained in the range processed, the rest can be processed traditionally, character by character or by repeating the process (offset+partial, length−partial), where partial is the size of the part that was already processed. This assumes that the offsets grow in the processing direction; several implementations do it vice versa, in which case this should be adapted. In the end, a new transition cache entry is created that maps.

An alternative embodiment is to associate the parse state change information only with reasonably bounded expressions, for example attributes, values, attribute/value pairs, entire tags (between angle brackets < >) and well-formed subtrees (natural expressions).

While this description describes its usage for XML documents, the same principle could be used to reconstruct other trees and directed acyclic graphs (DAGs) from linearized forms.

In the form described above, trees are in fact parsed into DOM DAGs, not DOM trees. If the DOM is to be modified later, a deep copy of the referenced subtree would be necessary, instead of the current pointer reference. If the source data structure is known to be a tree and a reference counting scheme is in place anyway, the transformation from DAG to tree could also be done only when modifying an entry where any of the ancestor nodes have a reference count>1.

For LZH, the compressor could also be cooperative, and try to match only natural expressions or at least not splitting tags or attribute names. This is expected to slightly reduce the compression ratio, but would remain compatible with all decompressors while improving performance, as the resulting operations would be faster to implement, as they would not stop mid-symbol (which would require symbol operations). As LZW compression is a longest-matching prefix problem, it would suit well to be combined with a longest-prefix matching engine. Often, techniques borrowed from longest-prefix matching are also employed for LZH compression.

Any disclosed embodiment may be combined with one or several of the other embodiments shown and/or described. This is also true for one or more features of the embodiments.

The present invention can be realized in hardware, software, or a combination of hardware and software. Any kind of computer system—or other apparatus, adapted for carrying out the method described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system—is able to carry out these methods.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention. The present invention can be realized in hardware, software, or a combination of hardware and software. A visualization tool according to the present invention can be realized in a centralized fashion in one computer system or in a distributed fashion where different elements are spread across several interconnected computer systems. Any kind of computer system—or other apparatus adapted for carrying out the methods and/or functions described herein—is suitable.

The present invention can be implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network. Computer program element or computer program in the present context means any expression, in any language, code or notation, of a set of instructions intended to cause a system having an information processing capability to perform a particular function either directly or after either or both of the following a) conversion to another language, code or notation; b) reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to affect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined only some of the more pertinent objects and embodiments of the present invention. This invention may be used for man applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A data processing method comprising receiving a compressed electronic document, decompressing the document and executing an analysis of the document during the decompression, the analysis determining whether the document conforms to defined syntax rules.

2. A method according to claim 1, further comprising terminating the decompression, if the analysis determines that the document does not conform to a said defined syntax rule.

3. A method according to claim 1, wherein, where the decompression uses a string table, the analysis comprises adding a further column to the string table, the further column comprising syntax information.

4. A method according to claim 1, wherein the step of executing an analysis of the document during the decompression, comprises parsing the document.

5. A method according to claim 1, wherein the step of executing an analysis of the document during the decompression, comprises validating the document.

6. A data processing system comprising an input device for receiving a compressed electronic document, and a processor unit arranged to decompress the document and to execute an analysis of the document during the decompression, the analysis determining whether the document conforms to defined syntax rules.

7. A system according to claim 6, wherein the processor unit is further arranged to terminate the decompression, if the analysis determines that the document does not conform to a defined syntax rule.

8. A system according to claim 6, wherein, where the decompression uses a string table, the analysis comprises adding a further column to the string table, the further column comprising syntax information.

9. A system according to claim 6, wherein the processor unit is arranged, when executing an analysis of the document during the decompression, to parse the document.

10. A system according to claim 6, wherein the processor unit is arranged, when executing an analysis of the document during the decompression, to validate the document.

11. A computer program product comprising program code for performing the steps of the method according to claim 1 when loaded in a computer.

12. A computer program product stored on a computer-readable medium comprising computer readable program code for causing a computer to perform the steps of the method according to claim 1.

13. An article of manufacture comprising a computer usable medium having computer readable program code means embodied therein for causing data processing, the computer readable program code means in said article of manufacture comprising computer readable program code means for causing a computer to effect the steps of
receiving a compressed electronic document,
decompressing the document, and
executing an analysis of the document during the decompression, the analysis determining whether the document conforms to defined syntax rules.

14. A program storage device readable by machine, tangibly embodying a program of instructions executable by the machine to perform method steps for data processing, said method steps comprising the steps of claim 1.

15. A method according to claim 2, wherein, where the decompression uses a string table, the analysis comprises adding a further column to the string table, the further column comprising syntax information.

16. A method according to claim 2, wherein the step of executing an analysis of the document during the decompression, comprises parsing the document.

17. A system according to claim 7, wherein, where the decompression uses a string table, the analysis comprises adding a further column to the string table, the further column comprising syntax information.

18. A system according to claim 6, wherein:
the processor unit is further arranged to terminate the decompression, if the analysis determines that the document does not conform to a defined syntax rule;
the processor unit is further arranged to terminate the decompression, if the analysis determines that the document does not conform to a defined syntax rule;
the decompression uses a string table, the analysis comprises adding a further column to the string table, the further column comprising syntax information;
the processor unit is arranged, when executing an analysis of the document during the decompression, to parse the document; and
the processor unit is arranged, when executing an analysis of the document during the decompression, to validate the document.

19. A method according to claim 1, further comprising terminating the decompression, if the analysis determines that the document does not conform to a said defined syntax rule, wherein:
where the decompression uses a string table, the analysis comprises adding a further column to the string table, the further column comprising syntax information;
the step of executing an analysis of the document during the decompression, comprises parsing the document; and
the step of executing an analysis of the document during the decompression, comprises validating the document.

20. A computer program product comprising a computer usable medium having computer readable program code means embodied therein for causing data processing, the computer readable program code means in said computer program product comprising computer readable program code means for causing a computer to effect the functions of claim 6.
